(19) United States
(12) Patent Application Publication
(10) Pub. No.: US 2009/0097859 A1
(43) Pub. Date: Apr. 16, 2009

(54) EMITTER, CONVERTER, AND DISPLAY SYSTEM USING SAME

(75) Inventors: Shu-Jen TSAI, Tu-Cheng (TW); Long-Fong CHEN, Tu-Cheng (TW); Wen-Haw TSENG, Tu-Cheng (TW); Shih-Fang WONG, Tu-Cheng (TW)

Correspondence Address: PCE INDUSTRY, INC.;ATT. Steven Reiss, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/966,997

(22) Filed: Dec. 29, 2007

(30) Foreign Application Priority Data
Oct. 12, 2007 (CN) 200710202042.3

(51) Int. Cl. H04B 10/00

(52) U.S. Cl. 398/140

(57) ABSTRACT

A display system includes an emitter and a converter. The emitter is used for emitting invisible light rays carrying to-be-displayed information. The converter is used for receiving the invisible light rays and converting the invisible light rays to be visible light rays, and emitting the visible light rays carrying the to-be-displayed information. The emitter includes an information source for generating display data from the to-be-displayed information, an encoder for encoding the display data to generate data packages, and an invisible light source for emitting the invisible light rays and modulating the data packages into the invisible light. An encoder and a converter are also disclosed.

### BACKGROUND

1. Field of the Invention

The present invention generally relates to display systems, and more particularly to an emitter, a converter corresponding to the emitter, and a display system using the emitter and the converter.

2. Description of Related Art

Nowadays, various displays, such as cathode-ray tube (CRT) displays, liquid crystal displays (LCD), organic light-emitting diode (OLED) displays are widely used in our daily life. For example, the displays are used in manufacturing, monitoring systems, entertainment, and in office environments.

In certain situations, users may want the displays to provide data security function. That is, to display information intended for certain users only. However, most present display systems do not provide this functionality.

Therefore, improvements for an emitter, a converter, and a display system using the emitter and the converter are needed in the industry to address the aforementioned deficiency.

### SUMMARY

A display system includes an emitter and a converter. The emitter is used for emitting invisible light rays carrying classified information to be displayed (hereinafter called “to-be-displayed information”). The converter is used for receiving the invisible light rays and converting the invisible light rays to be visible light rays, and emitting the visible light rays carrying the to-be-displayed information. The emitter includes an information source for generating display data from the to-be-displayed information, an encoder for encoding the display data to generate data packages, and an invisible light source for emitting the invisible light rays and modulating the data packages into the invisible light. An encoder and a converter are also disclosed.

Other advantages and novel features of the present invention will become more apparent from the following detailed description of preferred embodiment when taken in conjunction with the accompanying drawings.

### BRIEF DESCRIPTION OF THE DRAWINGS

FIG. 1 is a schematic diagram showing a display system in accordance with an exemplary embodiment;

FIG. 2 is a schematic, block diagram showing the display system of FIG. 1, the display system including an emitter and a converter; and

FIG. 3 is a schematic, block diagram showing detailed structure of the emitter and the converter of FIG. 2.

### DETAILED DESCRIPTION OF THE EMBODIMENTS

Reference will now be made to the drawings to describe a preferred embodiment of the present emitter, a preferred embodiment of the present converter, and a preferred embodiment of the present display system.

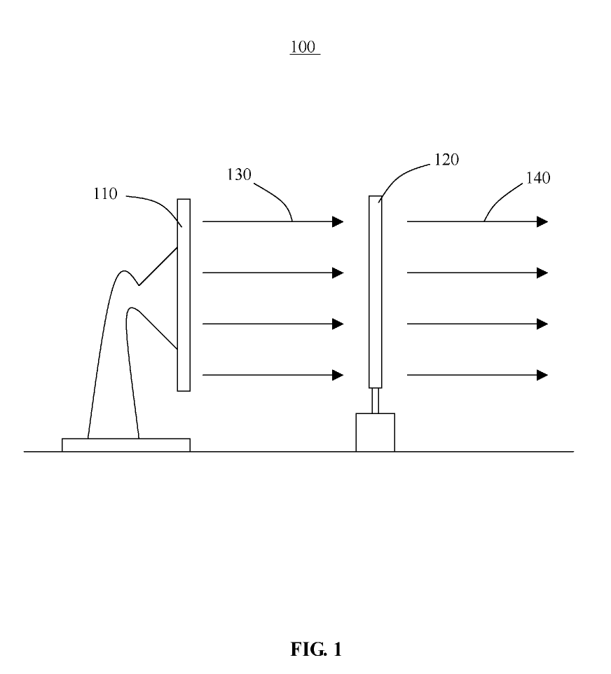

Referring to FIG. 1, a display system 100 in accordance with an exemplary embodiment includes an emitter 110 and a converter 120. The emitter 110 is used for emitting invisible light rays 130 carrying to-be-displayed information, such as image information, text information, and so on. The converter 120 is used for receiving the invisible light rays 130 and transforming the invisible light rays 130 to visible light rays 140, and emitting the visible light rays 140 carrying the to-be-displayed information. In the embodiment, wavelengths of the invisible light rays 130 are from 770 nm to 1000 nm, also known as infrared light.

When using the display system 100, the converter 120 can be properly placed such that only an intended user can view the to-be-displayed information through the converter 120, while other users would be unable to view the to-be-displayed information. Therefore, the converter 120 is an independent apparatus with respect to the emitter 110.

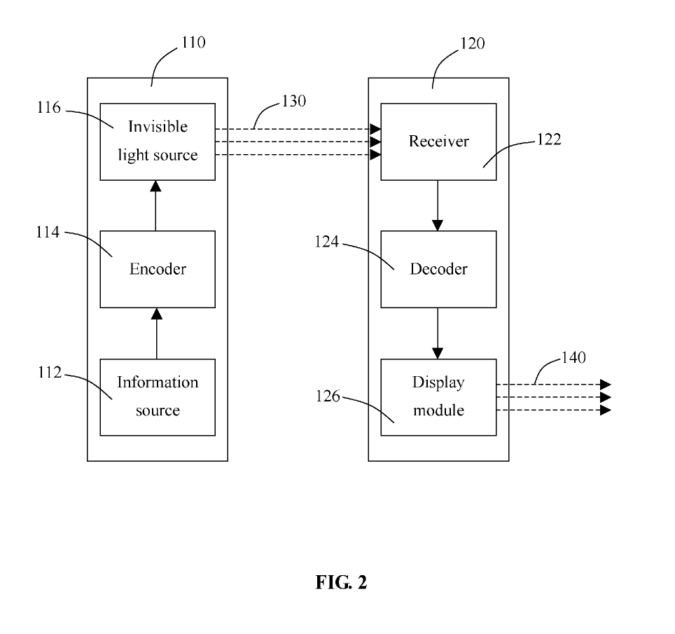

Referring to FIG. 2, the emitter 110 includes an information source 112, an encoder 114, and an invisible light source 116. The information source 112 is used for receiving the to-be-displayed information, and generating corresponding display data. The to-be-displayed information can be generated from computers, televisions, or other electronic apparatus. The encoder 114 is used for encoding the display data to generate data packages. The invisible light source 116 is used for emitting the invisible light rays 130, and modulating the data packages into the invisible light rays 130.

The converter 120 includes a receiver 122, a decoder 124, and a display module 126. The receiver 122 is used for receiving the invisible light rays 130, and demodulating the invisible light rays 130 to generate the data packages. The decoder 124 is used for decoding the data packages to generate the display data. The display module 126 is used for displaying the to-be-displayed information using the visible light rays 140 according to the display data.

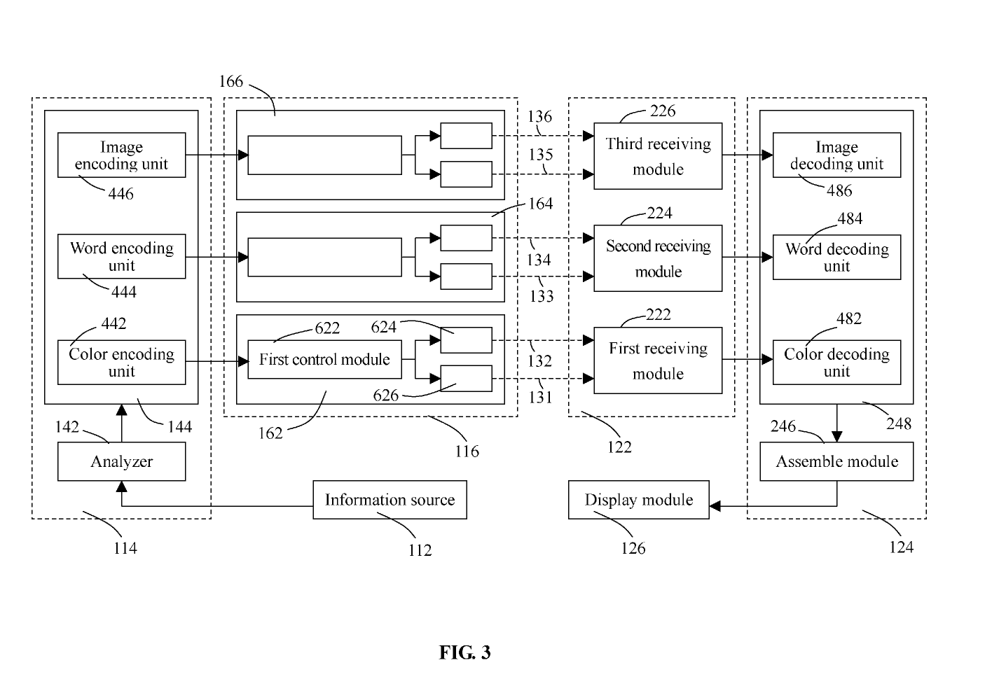

Referring to FIG. 3, the encoder 114 includes an analyzer 142 and an encoding module 144. The analyzer 142 is used for extracting the display data into a plurality of data types. In the embodiment, the display data is extracted into three data types, i.e. color data, word data, and image data. The encoding module 144 is used for encoding the color data, the word data, and the image data to generate corresponding data packages.

The encoding module 144 includes a color encoding unit 442, a word encoding unit 444, and an image encoding unit 446. The color encoding unit 442, the word encoding unit 444, and the image encoding unit 446 are used for encoding the color data, the word data, and the image data, to generate color data packages, word data packages, and image data packages respectively.

The invisible light source 116 includes a first emitting module 162, a second emitting module 164, and a third emitting module 166 respectively corresponding to the color encoding unit 442, the word encoding unit 444, and the image encoding unit 446. The three emitting modules 162, 164, 166 have the same functions, thus, for exemplary purposes, only the first emitting module 162 is depicted in detail as follows. The first emitting module 162 is used for receiving the color data packages, and emitting two invisible light rays 131, 132 carrying the color data packages. The first emitting module 162 includes a first control unit 622, and two emitting units 624, 626. The first control unit 662 is used for controlling the two emitting units 624, 626 to emit the invisible light rays 131, 132 according to the color data packages.

The second emitting module 164 and the third emitting module 166 have the same structure with the first emitting module 162. The second emitting module 164 emits invisible light rays 133, 134, and the third emitting module 166 emits invisible light rays 135, 136. In the embodiment, the invisible light rays 131, 132, 133, 134, 135, 136 have corresponding wavelengths. The wavelengths of the invisible light rays 131, 132, 133, 134, 135, 136 are 770 nm, 810 nm, 850 nm, 890 nm, 930 nm, 970 nm respectively.

The receiver 122 includes a first receiving module 222, a second receiving module 224, and a third receiving module 226. The first receiving module 222 is used for receiving the invisible light rays 131, 132, and demodulating the invisible light rays 131, 132 to generate the color data packages. The second receiving module 224 is used for receiving the invisible light rays 133, 134, and demodulating the invisible light rays 133, 134 to generate the word data package. The third receiving module 226 is used for receiving the invisible light rays 135, 136, and demodulating the invisible light rays 135, 136 to generate the image data packages.

The decoder 124 includes an assemble module 246 and a decoding module 248. The decoding module 248 includes a color decoding unit 482, a word decoding unit 484, and an image decoding unit 486 for decoding the color data packages, the word data packages, and the image data packages to generate the color data, the word data, and the image data. The assemble module 246 is used for assembling the color data, the word data, and the image data to generate the display data.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A display system comprising:
an emitter for emitting invisible light rays carrying to-be-displayed information, the emitter comprising an information source for generating display data from the to-be-displayed information, an encoder for encoding the display data to generate data packages, and an invisible light source for emitting the invisible light rays and modulating the data packages into the invisible light; and
a converter for receiving the invisible light rays and converting the invisible light rays to visible light rays, and emitting the visible light rays carrying the to-be-displayed information.

2. The display system according to claim 1, wherein the converter comprises a receiver for receiving the invisible light rays and demodulating the invisible light rays to generate the data packages.

3. The display system according to claim 2, wherein the converter further comprises a decoder for decoding the data packages to generate the display data.

4. The display system according to claim 3, wherein the converter further comprises a display module for displaying the to-be-displayed information.

5. The display system according to claim 1, wherein wavelengths of the invisible light rays are from 770 nm to 1000 nm.

6. An emitter comprising:
an information source for receiving to-be-displayed information, and generating display data;
an encoder for encoding the display data to generate data packages, and an invisible light source for emitting the invisible light rays and modulating the data packages into the invisible light; and
a converter for receiving the invisible light rays and converting the invisible light rays to visible light rays, and emitting the visible light rays carrying the to-be-displayed information.

7. The emitter according to claim 6, wherein the encoder comprises an analyzer for extracting the display data into color data, word data, and image data.

8. The emitter according to claim 7, wherein the encoder further comprises an encoding module for encoding the color data, the word data, the image data to generate color data packages, word data packages, and image data packages.

9. The emitter according to claim 8, wherein the encoding module comprises a color encoding unit for encoding the color data, a word encoding unit for encoding the word data, and a image encoding unit for encoding the image data.

10. The emitter according to claim 9, wherein the invisible light source comprises a first emitting module for emitting a first invisible light ray and a second invisible light ray carrying the color data packages, a second emitting module for emitting a third invisible light ray and a fourth invisible light ray carrying the word data packages, and a third emitting module for emitting a fifth invisible light ray and a sixth invisible light ray carrying the image data packages.

11. The emitter according to claim 10, wherein the first emitting module includes a first control unit and two emitting units for emitting the first invisible light ray and the second invisible light rays, and the emitting units is controlled by the first control unit according to the color data packages.

12. The emitter according to claim 10, wherein wavelengths of the first, second, third, fourth, fifth, sixth invisible light rays are 770 nm, 810 nm, 850 nm, 890 nm, 930 nm, 970 nm correspondingly.

13. A converter for receiving invisible light rays carrying data packages comprising:
a receiver for receiving the invisible light rays, and demodulating the invisible light rays to generate the data packages;
a decoder for decoding the data package to generate display data; and
a display module for displaying to-be-displayed information using visible light rays according to display data.

14. The converter according to claim 13, wherein the receiver comprises a first receiving module for demodulating the invisible light rays to generate color data packages, a second receiving for demodulating the invisible light rays to generate word data packages, and a second receiving for demodulating the invisible light rays to generate image data packages.

15. The converter according to claim 14, wherein the decoder comprises a decoding module for decoding the color data packages, the word data packages, and the image data packages to generate color data, word data, image data.

16. The converter according to claim 15, wherein the decoder comprises an assembler for assembling the color data, the word data, and the image data to generate display data.
